(19) United States
(12) Patent Application Publication
(10) Pub. No.: US 2025/0265920 A1
(43) Pub. Date: Aug. 21, 2025

(54) EMERGENCY REAL-TIME LOCATION AND PHYSICAL MONITORING SYSTEM AND METHOD

(71) Applicant: Russell Ketchum, San Clemente, CA (US)

(72) Inventor: Russell Ketchum, San Clemente, CA (US)

(21) Appl. No.: 18/984,719

(22) Filed: Dec. 17, 2024

Related U.S. Application Data
(60) Provisional application No. 63/611,390, filed on Dec. 18, 2023.

(51) Int. Cl. G08B 25/01; G08B 25/00; G08B 25/10; H04W 4/02

(52) U.S. Cl. CPC G08B 25/016; G08B 25/009; G08B 25/10; H04W 4/027

(57) ABSTRACT

A system and method for real-time location and physical monitoring in an emergency. Included are: a computing application providing a GUI, the GUI providing at least: a location mapping of the emergency; and a location and health status of persons within the location mapping; a plurality of wristbands provided to substantially all of the persons, the wristbands comprising a wireless communication capability, an accelerometer, and a unique wireless identifier; a plurality of wireless hubs throughout the location mapping that receive at least the wireless communication from the wristbands, including at least data from each of the accelerometers and from each of the unique wireless identifiers; and a cloud-based backend communicative via wire and wirelessly with the plurality of wireless hubs, the backend including an algorithmic module configured to provide the location and the health status for each wristband wearer based on the data from each of the accelerometers and each of the unique wireless identifiers.

### BACKGROUND

### Field of the Disclosure

The disclosure relates to location monitoring, and, more particularly, to an emergency real-time location and physical monitoring system and method.

### Description of the Background

It is an unfortunate truth of modern society that emergencies often arise in contexts where large numbers of people are present. For example, natural disasters are on the rise, and incidences of active shooters have continued to occur.

A frequent problem in such situations is detailed knowledge by outside personnel of what is happening inside of the location where the large numbers of people are present. It is, unfortunately, a very frequent state, such as during an active shooting, that loved ones don't know the status, or even presence, of their family member or friend until long after the emergency has ended.

Worse yet, first responders, law enforcement, and medical personnel also often are similarly “in the dark”. Unfortunately, a lack of insight for these personnel into the nuances of the situation often drastically slows response times, and can lead to poor choices in the manner of response to the situation.

Therefore, a need exists for an improved emergency real-time location and physical monitoring system and method.

### SUMMARY

The embodiments are and include a system and method for real-time location and physical monitoring in an emergency situation. The system and method include: a computing application providing a graphical user interface (GUI), the GUI providing at least: a location mapping of the emergency situation; and a location and health status of persons within the location mapping; a plurality of wristbands provided to substantially all of the persons, the wristbands comprising a wireless communication capability, an accelerometer, and a unique wireless identifier; a plurality of wireless hubs located throughout the location mapping, wherein the wireless hubs receive at least the wireless communication from the wristbands, the wireless communication including at least data from each of the accelerometers and from each of the unique wireless identifiers; and a cloud computing backend communicative via wire and wirelessly with the plurality of wireless hubs, the backend including an algorithmic module configured to provide the location and the health status for each wristband wearer based on the data from each of the accelerometers and each of the unique wireless identifiers.

### BRIEF DESCRIPTION OF THE DRAWINGS

The disclosure provided herein describes and includes the accompanying drawings, in which like numerals may represent like elements, and wherein:

FIG. 1 illustrates an exemplary system according to the embodiments;

FIG. 2 is a flow diagram illustrating a method according to the embodiments; and

FIG. 3 illustrates features of the embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are well known in the art, and because they do not facilitate a better understanding of the present disclosure, a discussion of such elements and operations is not provided herein. However, the present disclosure is deemed to inherently include all such elements, variations, and modifications to the described aspects that would be known to those of ordinary skill in the art.

Description is provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments described are exemplary in nature, and should not be construed to limit the scope of the disclosure.

The terminology used herein is for the purpose of describing particular exemplary embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules and systems are disclosed herein that may provide access to and transformation of a plurality of types of digital content, including but not limited to plans and data streams, and the algorithms applied herein may track, deliver, manipulate, transform, transceive and report the accessed content. Described embodiments of these modules, apps, systems and methods are intended to be exemplary and not limiting.

An exemplary computing processing system for use in association with the embodiments, by way of non-limiting example, is capable of executing software, such as an operating system (OS), applications/apps, user interfaces, and/or one or more other computing algorithms, such as the algorithms, decisions, models, programs and subprograms discussed herein. The operation of the exemplary processing system is controlled primarily by non-transitory computer readable instructions/code, such as instructions stored in a computer readable storage medium, such as hard disk drive (HDD), optical disk, solid state drive, Random Access Memory (RAM), a flash memory, or the like. Such instructions may be executed within the central processing unit (CPU) to cause the system to perform the disclosed operations. In many known computer servers, workstations, mobile devices, personal computers, and the like, the CPU is implemented in an integrated circuit called a processor.

It is appreciated that, although the exemplary processing system may comprise a single CPU, such description is merely illustrative, as the processing system may comprise a plurality of CPUs. As such, the disclosed system may exploit the resources of remote CPUs through a communications network or some other data communications means.

In operation, CPU fetches, decodes, and executes the instructions from the computer readable storage medium. Information, such as the computer instructions and other computer readable data, is transferred between components of the computing system via the system's main data-transfer path.

In addition, the processing system may contain a peripheral communications controller and bus, which is responsible for communicating instructions from CPU to, and/or receiving data from, peripherals as discussed herein throughout. An example of a peripheral bus is the Peripheral Component Interconnect bus that is well known in the pertinent art.

An operator display/graphical user interface (GUI) may be used to display visual output and/or presentation data generated by or at the request of processing system, such as responsive to operation of the aforementioned computing programs/applications. Such visual output may include text, graphics, animated graphics, and/or video, for example.

Further, the processing system may contain a network adapter which may be used to couple to an external communication network, which may include or provide access to the Internet, an intranet, an extranet, or the like. Communications network may provide access for processing system with means of communicating and transferring software and information electronically. Network adaptor may communicate to and from the network using any available wired or wireless technologies. Such technologies may include, by way of non-limiting example, cellular, Wifi, Bluetooth, infrared, or the like.

The embodiments provide real-time situational awareness and emergency response to system owners, operators, and to those having shared access, such as law enforcement agencies, medical response teams, fire and rescue, and the like. The embodiments may provide an overarching system and method of providing this situational awareness and emergency response. The system may combine hardware, software, firmware and physical items to arrive at the disclosed embodiments.

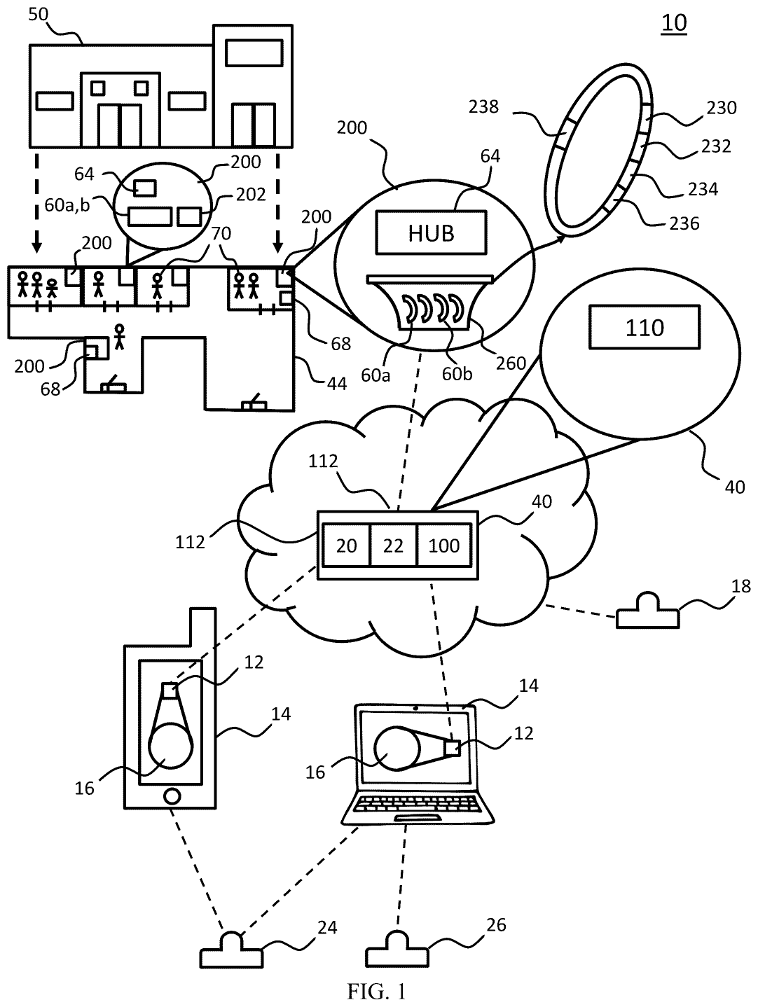

More particularly, the system 10, as illustrated in FIG. 1, may include a computing application 12, or “app”, which will be understood to be available as a desktop, web-based, and/or mobile application, such as on a desktop, laptop, tablet, or mobile device 14. The app may include one or more graphical user interfaces (GUIs) 16, which may or may not vary by user type. Access to the app may be subject to the control of an administrator 18, and may have both those granted “regular access” 20, and those granted “emergency access” 22. Accordingly, the app may provide administrative access to system operators and is thus the means by which the system is configured, accessed, and used.

A regular access user 24 may register to use the app, and the backend information accessible to the app, as will be appreciated by the skilled artisan, and that registrant use may be subject to administrative permissions based on the type of registering user, i.e., for a school, regular user access types may include school administrator, teacher, parent, school staff, school security, etc., as is typical of an “app” usage. Regular users may also include situational awareness and emergency monitors, and like personnel outside of, for example, the school in the present exemplary-use situation.

Distinct from a regular user, an emergency access user 26 may not be registered as a typical app user. However, the emergency user may be granted varying access or app feature use in the case of an emergency. This emergency access may be manually granted by an administrator, or may be automatically granted by an artificial intelligence module or rules-based module that is either trained or subject to a plurality of rules, respectively, to recognize the levels of app permissions required for particular emergency access personnel based on the type of an emergency situation.

The backend accessible to the app may preferably be at least a cloud-based computing backend to thereby provide data and access backup and redundancy in an emergency, although the backend may also be “thin client”, i.e., may be available on-site. The backend may provide connectivity between physical monitoring equipment, such as that discussed herein throughout, and the computing interface to the app(s).

The backend 40 provides computer processing of input data from a variety of sources in a variety of languages and formats, and synthesizes all input to create human-readable, emergency-actionable output, such as to the app/GUI. This input to the backend may not be entered simultaneously. By way of non-limiting example, a detailed map 44 of all areas of a school, hospital, office, or the like 50 may be input at a first time, and at a later time the backend may receive Bluetooth, near field communications (NFC), or similar data on positions of persons on the map, such as using the network discussed herein formed of wristbands 60a, b and a plurality of variously located wireless hubs 64. Of course, the positions of persons 70 may also be indicated by infrared (IR), optical, or other data input to the backend. Similarly and additionally, the aforementioned or other types of sensing 68 may also generate input to the backend indicating sounds, environmental conditions, or health data of persons in the emergent situation, for example.

The backend may then apply a plurality of rules and algorithms 100 to the input information received in order to make conclusions, projections, or the like, and to therefrom generate actionable output to the app/GUI. By way of non-limiting example, such rules and algorithms 100 may overlay a sensed location of persons 70 onto the aforementioned map 44, may make situational assessments, and may thus employ and engine/module 110 capable of artificial intelligence and/or machine-learned pattern recognition and predictive capabilities to classify the data received at the backend inputs 112 to be best used by system operators, first responders, emergency personnel, in-situation persons, and so on. As such, the backend may include the AI engine or module 110 that learns, such as upon initial training, over time, and across multiple situations (which may be actual or data-created), inferences to be drawn from data received at the inputs to the backend.

In the third subsystem 200 of the disclosed system and method, a physical monitoring system which generates the inputs 112 to the backend 40 is provided. The physical system may principally include at least a person-location monitor 60a, b, and a plurality of in-situ communications hubs 64 that are communicatively connected to both the person-location monitors 60a, b and the remote and/or local thin-client backend 40. In additional and alternative embodiments, the physical system may additionally include a variety of other features 202 interfaced to the app and/or the backend, such as but not limited to on-site electronic door lock access, on-site drone access, interfacing to on-site video and/or audio monitoring, such as cameras and speakers, as well as access to local cellular communications, law enforcement and first responder communication interfacing, and so on.

Specifically, the physical system may include at least consisting of at least one Internet connected, Bluetooth/NFC/Wifi-enabled base station 64, herein also referred to as a wireless local hub, capable of collecting information from local beacons/tags 60a, 60b, 68, such as at least the person-location monitors, for uploading to the backend. In some embodiments, BLE (Bluetooth Low Energy) may be preferred for localized on-site communications, although other communication methodologies may be used as discussed throughout. The at least one base station may include built-in redundancies, such as having both wired and wireless internet connectivity and battery backup in the event of loss of power. The at least one base station may, but need not, be capable of receiving multiple modalities of communications from beacons/tags 60a, 60b, 68, such as receiving BLE communications from person-location monitors, Wifi/cellular communications from mobile devices near the base station(s), silent alarm signalling, infrared data, and so on, and the communication from the base station(s) may be one-way or two way, such as wherein outgoing communications and/or data, such as Wifi direction signals to an in-situ drone, also occur.

Further, a single or limited number of base stations 64 may be present on the site. Alternatively, a more significant number of base stations 64 may be on-site, such as may be necessary to cover all areas on the aforementioned computerized map at which person-location monitors may be present.

The person-location monitors may be, for example, monitoring wristbands 60a, 60b intended to be worn by people at least during an occurrence of an emergency. Although these personal monitors may be any type of device capable of communicating with the local wireless hub(s), including cell phones or health monitors, such as FitBits, in the principal embodiment the person-location monitors may comprise wristbands.

These wristbands may be assigned to persons in advance and/or worn on a regular basis, may be handed out only upon occurrence of an emergency, and in either case may or may not pair to the wearers' mobile device. The wristbands may contain at least a BLE beacon 230, accelerometer 232, and a NFC/RFID chip 234, and may additionally include other sensors (such as health, heartrate, or Fitbit-style sensors) 236 and/or communication modalities 238. As such, the wristbands may broadcast their data to the nearest base station(s) 64, tied to a unique identifier, such as the RFID.

The disclosed system may or may not include an automated activation. By way of non-limiting example, signal suppressing storage 260 for wristbands, such as a Faraday bag or physical off button, may prevent data transmission from the wristbands to the base station when not in active use, and when the system does not “see” the wristbands, it may remain dormant. However, if the system is activated, but some portions of the mapping remain “dark”, that constitutes evidence that the emergency is most acute in the “dark” area of the mapping.

Optional embodiments may include various additional features as discussed throughout. Such alternatives may include, for example, the integration of autonomous drones capable of interacting with data collected by the physical monitoring system and/or generated from the backend may be installed in “readiness areas”, as discussed herein above.

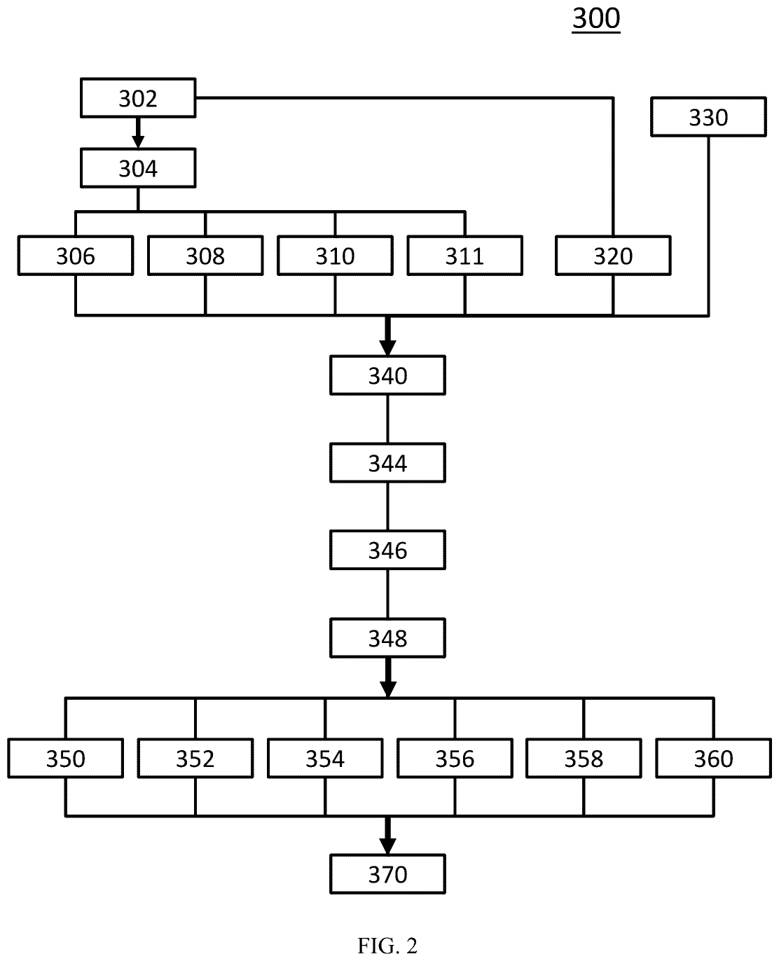

In an exemplary application, and as illustrated in the flow diagram of FIG. 2, the disclosed system 10 may be implemented in method 300. The disclosed system may be deployed/installed in a setting that may be particularly subject to a broad emergency situation, such as a hospital, office tower, or school, and may be activated upon occurrence of an emergency situation, such as a natural disaster like an earthquake, an attack, or in the event of an active shooter, by way of non-limiting example.

In the disclosed exemplary method, the first phase 302 may be pre-emergency/installation. Phase one may thus include a digital setup 304 of the system, such as in which digital records may be created in the backend system to create a virtual representation, i.e., the disclosed computerized mapping, of, for example, the school for which the system is being installed 306, account setup 308, as well as any requisite hierarchies and/or AI training 310 and other data entry 311.

For example, a school may be represented by regular user account records, such as parent accounts, student accounts, school district accounts, teacher accounts, school security accounts, main campus accounts, satellite campus accounts, and so on. Each account record may contain all relevant information for that school (e.g., address, grade levels, classroom assignments, daily schedule, etc.). Other digital account records may also be created, such as for non-school entities such as the local police and fire departments.

User records (including record groups) may be created to correspond to people who should have access to the system. An administrated permissioning system may then control the interaction between records—in practice, this includes controlling who can see and do what with the system. By way of non-limiting example, senior school officials may be system owners, and may have full administrative access to the app; junior school officials may be assigned viewing access to the entire system; individual teachers may have viewing access to their classrooms, portions of the school, and/or the entire school building in which they work, and may have “emergency update” access for their classrooms; students and parents may be given view and/or read/write access to view and/or update information about one (or multiple) students, and may have “emergency access” to classroom views as dictated by the student's individual schedule; and emergency responders may be granted real-time access to all system aspects, either at all times or solely during an active emergency.

Also included in the digital records generation is a 3D mapping session of the relevant building, i.e., the school in the example above. Thus, during installation, the entire school may be 3D scanned (such as via LIDAR, etc.) to create a precise 3D map of the facility and grounds. The map may then be associated with the appropriate account record(s).

The mapping may be annotated to denote specific rooms (e.g., by classroom number) and to otherwise divide the map into meaningful partitions. Additional data/metadata may be associated with the map and/or specific partitions.

For example, a classroom may be assigned its real-world classroom number. Subsequently, the teacher's name, student count by time of day, names of students assigned to the classroom (by day/date/time if needed), known medical conditions of students by time/day, etc., may be associated with a classroom to create a highly detailed representation of who should be in a classroom at any given time.

The mapping may be supplemented by data from other systems and feeds, and may be updated in real-time. For example, a data feed from the daily attendance tracking system may be integrated to denote any students not present in the class at a given day/date/time.

The next aspect of the pre-emergency system may include at least portions of the physical system installation 320. Physical-monitoring base stations may be installed as needed, such as in every classroom, every hall, every common area, etc. Each base station may be located in a permanent and fixed location and those coordinates, along with the device's identifier, may be logged on the 3D map.

Also in this aspect of the installation, each classroom may be assigned personal monitoring, such as wristbands. The wristbands may be associated with a “home base station”, which may also associate them by a unique identifier of the wristband with a classroom in which the base station resides. There may be different types of wristbands assigned, such as blue-colored for students and red-colored for adults, which may be reflected by the unique identifiers (such as the RFID) of each wristband digitally. It may be preferred to have several excess/differently colored/differently categorized digitally wristbands per classroom, such as to account for guests or visitors that may be in the room at the time of an emergency.

Once registered to the system, the wristbands may then be stored, such as inside a signal suppressing container (e.g., a Faraday bag) that blocks all transmissions from the wristbands to the receiver. Thereafter in such an embodiment, if all assigned wristbands are disconnected from their home receiver, the system may go into standby mode automatically.

Additionally, other physical features may occur at phase four. For example, drones may be prepositioned on landing pad/charging stations throughout the school and set into standby mode.

One install is complete, protocol integration and individual training 330 may be provided, For example, existing emergency response plans may be updated to incorporate use of the installed system. Teachers, students, and faculty may be given initial training on the system. Supplemental training may be incorporated into periodic disaster-preparedness drills, by way of example.

Needless to say, the method then includes in-emergency steps 340 that occur during an active emergency. Using the above example of an active school shooter incident, the school may be placed on lockdown subject to existing protocols.

In the classroom, once in lockdown, the teacher or other responsible party may retrieve the Faraday bag containing the wristbands and may then distribute wristbands 344, such as based on the visual cues 60a, 60b of wristband type discussed herein, to whoever is present in the classroom. For example, the teacher might put a red wristband on him/herself 60a, a blue wristband 60b on all students, and a yellow wristband on all visitors. Excess wristbands may then be resealed in the Faraday bag, indicating to the local hub that those wristbands are not active, i.e., are not corresponded to a person in the emergency.

As the result of opening the Faraday bag, the base station may begin to receive data from each wristband 346. Based on these initial signals, the system may go into alert mode 348, which may include a lockdown and automated opening of a channel to/informing first responder and law enforcement. As students move to assigned areas (i.e., desks, back of classroom, away from door, etc.), significant motion, movement, and separation will occur relative to each wristband and the base station receiver. Also, at this juncture, the wristbands may or may not be officially corresponded to an individual child by name—for example, the teacher may have an NFC tap pad on her desk, and may move through a class list and tap each wristband to the tap pad as the wristband is handed out while moving through the class list, All of the foregoing data, and any additional requisite data, is sent to the backend system for realtime processing 350.

Having declared a lockdown, the school administration has signaled that it's time to activate the system 348. Alternatively, the system may activate by other means. For example, in a situation where classroom A hears gunshots from classroom B, classroom A may deploy their wristbands proactively. By doing so, the system will sense the opening of a Farraday bag, and will trigger the school's lockdown procedures automatically. Further, by deploying the wristbands, an early warning notification may be sent to the school administration. Simultaneously, the teacher may receive a notification on his/her mobile device, or on an in-classroom audio system, and/or on the teacher's computing device, asking the teacher to confirm the existence of an actual emergency, the nature of the emergency, and to report whatever details are available. By confirming the emergency, the teacher triggers the school lockdown and starts the data flow to the backend for the decision-making portion of the emergency.

Once the school is in lockdown and classrooms have deployed their wristbands, school officials have a realtime view of classrooms and everyone therein 352, which conveys critical information. Further, at the discretion of the system administrator and in cooperation with law enforcement and first responders, the system may be configured to notify agencies, individual officers, the aforementioned law enforcement and first responders, etc., either automatically or by permission of a school administrator as the emergency and the lockdown is declared, when a lockdown event has been triggered. This provides those parties external to the emergency (i.e., outside of the school, office, hospital, etc.) direct access to all systems data, such as for the duration of the emergency, indefinitely, or the like 354.

Moreover, many agencies have created various policies, such as wherein all nearby resources are to converge on a position, such as a school, directly when an emergency has been declared. Similarly, many schools and agencies have joined the Hero 911 network, which allows for teachers to declare emergencies and for appropriate law enforcement to be notified. The system may be integrated with any such system 356, such as to trigger or receive alerts. Accordingly, in a case wherein a law enforcement officer, for example, receives a notification and prior instruction to go directly to the site of the emergency, the system may provide critical information while the officer is enroute and continue to do so while on-scene.

The system thus senses wristbands wherever and as quickly as possible following, or upon causation by the wristband bag opening of, the declaration of a lockdown. Once deployed, a variety of data may be immediately accessible to those with access to the app GUI, and/or to the AI engine that may aid in the decision-making process.

Chief among the available data may be the precise location information of individuals within the emergency setting. Given the known fixed location of each base station in relation to the 3D map, the backend readily calculates the precise location of each BLE wristband from its home base station and, in turn, where each wristband is located even when it moves 352. Of course, in embodiments without wristbands or in addition to wristbands, the base station may perform other types of sensing, such as infrared sensing, to locate positions or health of persons in an emergency setting, and may overlay this information with the wristband information in a context where both data types are available.

In addition to this “headcount location” information, wristbands may also provide status information 358. For example, by comparing the number of wristbands connected to the system with the time-of-day attendance records, particularly at each base station location, the system may provide an initial headcount estimate of the number of people that are accounted for at each location. This view may be augmented and updated with additional information from the system as the situation unfolds. Also among the data discerned by the backend with respect to headcount may be data indicative of a basic categorization of persons, such as based on wristband color coding, into basic categories, such as students, teachers and guests in the example above.

As mentioned throughout, the backend may also make indirect conclusions, predictions, and/or recommendations based on the received data, such as using the AI engine discussed throughout 360. For example, the accelerometer and/or other sensors in each wristband may report or provide data signals from which inferences can be drawn. By way of non-limiting example, a completely immobile wristband (especially one that had been moving previously) may indicate a fatality; a wristband in limited motion, such as merely quivering arm, but that otherwise remains stationary relative to the base station may indicate a severe injury; and a wristband within “normal” motion parameters may indicate a person that is uninjured.

In the aggregate and again using the school shooter example, classrooms that become “less healthy” over the course of the emergency may indicate the likely location of the shooter in real time. Further pattern analysis of the impacted classrooms may be used to predict the next likely target or the shooter's likely route.

In the foregoing situation as the emergency ends, or in the event of a false alarm or drill, students may go to their teacher and scan the RFID chip in their wristbands into the app, such as on the teacher's mobile device. The teacher may then check-in the student and report their status (e.g., injured, nothing to report, etc.) 370. By doing so, the teacher provides a realtime headcount and health status to school officials, law enforcement, first responders, and/or families. As such, based on the school's account settings, each parent/guardian of an individual student may receive a notification on his/her mobile device relaying the status of the child and specifying next steps.

As mentioned above, if a classroom has the active shooter present therein, the wristbands would likely not be deployed. The fact that the wristbands are not deployed is significant, at least in that a dark classroom (in standby mode) as other classrooms report-in may likely signal the initial location of the shooter.

Communications for those involved with the emergency may be fully managed by the system. For example, text/audio/visual communication (at 1:1, 1:n, or non ratios) may be managed through the app, and may or may not use encryption. Automated alert communications may be generated to communicate information to/from those in the school, involved in the response effort, persons who have the roles of parents/guardians, and/or even the extended community, such as through local news outlets, as the situation evolves.

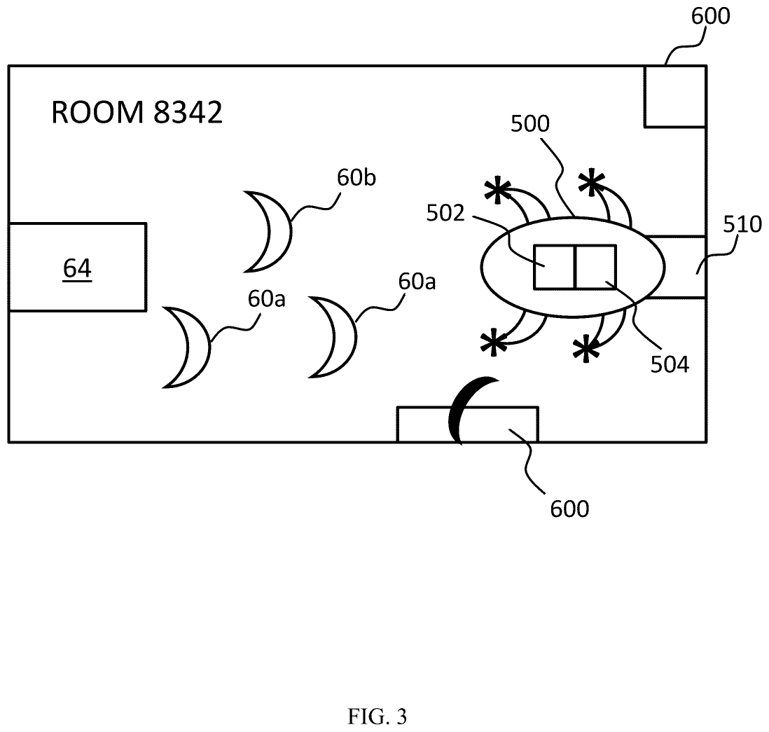

In additional and alternative embodiments, and as shown in FIG. 3, an autonomous drone or drones 500 may be prepositioned for manual- or self-deployment for use with the disclosed system 10. For example, the drone may be fed an AI engine-generated prioritized list of areas to investigate 502 directly from the core backend. Drone sensors 504 (e.g. thermal imaging, video with recognition, etc.) may then collect data that would augment the situational awareness view created by the system to provide more data or to improve predictive signals. The drone may dock 510 on-site, such as for maintaining charge, and may communicate using hubs 64.

Other “smart” devices and signals 600 may be incorporated into the backend and/or to the physical monitoring system. For example, if electronic locks are available, a lockdown may automate door locking, may make doors inaccessible along the suspected (such as by the AI engine) path of the shooter, and/or an assessment may be made whether and which doors are locked. Lights in a given area may be assessed as on or off, or may be turned on or off. The system may assess whether the emergency first aid kit storage door has been opened, and/or whether contents thereof, such as bandages, chest/bullet tape, and so on, have been employed.

Similarly, security camera networks 600, such as within the emergency zone, may provide video links to the system. Thereby, a shooter may be located, damage and health assessments may be made, and interface to facial recognition by the backend may enable identification of persons in a video feed, such as the unhealthy or a shooter.

Third party data, such as weather/environmental feeds, may be integrated to augment the view provided by the system, such as to increase the accuracy of the predictions and signals provided. Local maps may lead to a conclusion by the AI of likely escape paths for a person-of-interest. The third part data may also help discriminate types of emergencies, both for the emergency declared and for other emergencies happening at the same time, such as earthquakes, blizzards, flooding, tornadoes, and the like. Yet further, third party data may be provided to the AI engine to improve the inferences drawn thereby, as may be automatic after-action reporting and feedback to improve inferences drawn and response protocols.

The system data may also be integrated with third party situational awareness tools in use by law enforcement and other agencies (e.g., ATAK). This may provide the system with enhanced visibility into an agency's platform of choice, and unify the access point for all information for law enforcement, first responders, medical personnel and fire and rescue.

The data produced by the system is extremely sensitive. Thus, data security is of paramount importance. Accordingly, end-to-end encryption may preferable be employed, as discussed throughout.

First responders should also be aware of local sites that operate the disclosed system and method. Otherwise, the benefits disclosed may be unavailable to them, and, worse yet, they may intentionally or inadvertently override or disable the system.

The disclosed system should be resilient. Accordingly, redundant Wifi and wired internet connections, hard-wired power with backup battery power, and a capability between the base station hubs of the system to create a private ad hoc mesh network to ensure uninterrupted, direct, private communications are all features that may be provided in the system in the embodiments.

The cloud services discussed throughout may be offered as a SAAS model. Various tiering of such a model may include remote monitoring, centralized monitoring, access to expert analysts, etc. Further, access to the disclosed system may be bundled with various other features, such as the drones discussed herein, first aid kits (which may associate with or include the disclosed base station hubs, such as via beacons/tags), items within first aid kids, such as bullet-repair tape (which also may have beacons/tags), and so on.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features claimed as follows.

What is claimed is:

1. A system for real-time location and physical monitoring in an emergency situation, comprising:
a computing application providing a graphical user interface (GUI), the GUI providing at least: a location mapping of the emergency situation; and a location and health status of persons at a geographic location corresponded to the location mapping;
a plurality of wristbands provided to substantially all of the persons, the wristbands comprising a wireless communication capability, an accelerometer, and a unique wireless identifier;
a plurality of wireless hubs located throughout the geographic location, wherein the wireless hubs receive at least the wireless communication from the wristbands, the wireless communication including at least data from each of the accelerometers and from each of the unique wireless identifiers; and
a cloud computing backend communicative via wire and wirelessly with the plurality of wireless hubs, the backend including an algorithmic module configured to provide the location and the health status for each wristband wearer to the GUI based on the data from each of the accelerometers and each of the unique wireless identifiers.

2. A system for real-time location and physical monitoring in an emergency situation, comprising:
a computing application providing a graphical user interface (GUI), the GUI providing at least: a location mapping of a physical site of the emergency situation; and a location and health status of persons within the location mapping;
a plurality of physical monitoring devices provided to substantially all of the persons, the physical monitoring devices comprising a wireless communication capability, an accelerometer, and a unique wireless identifier;
a plurality of wireless hubs located throughout the location mapping, wherein the wireless hubs receive at least the wireless communication from the physical monitoring devices, the wireless communication including at least data from each of the accelerometers and from each of the unique wireless identifiers; and
a cloud computing backend communicative via wire and wirelessly with the plurality of wireless hubs, the backend including an algorithmic module configured to discern the location and the health status for each holder of a physical monitoring device based at least on the data from each of the accelerometers and each of the unique wireless identifiers.

3. A method for real-time location and physical monitoring in an emergency situation, comprising:
providing a computerized graphical user interface (GUI) having at least: a location mapping of a geographic location corresponding to the emergency situation; and a location and health status of persons at the geographic location on the location mapping;
providing a plurality of physical monitoring devices to substantially all of the persons, the physical monitoring devices comprising a wireless communication capability, an accelerometer, and a unique wireless identifier;
locating a plurality of wireless hubs throughout the geographic location, wherein the wireless hubs receive at least the wireless communication from the physical monitoring devices, the wireless communication including at least data from each of the accelerometers and from each of the unique wireless identifiers; and
a cloud computing backend communicative via wire and wirelessly with the plurality of wireless hubs, the backend including an algorithmic module configured to provide the location and the health status for each holder of a physical monitoring device on the GUI based at least on the data from each of the accelerometers and each of the unique wireless identifiers.
